(19) United States
(12) Patent Application Publication
(10) Pub. No.: US 2014/0115326 A1
(43) Pub. Date: Apr. 24, 2014

(54) APPARATUS AND METHOD FOR PROVIDING NETWORK DATA SERVICE, CLIENT DEVICE FOR NETWORK DATA SERVICE

(71) Applicant: Electronics and Telecommunications Research Institute, (US)

(72) Inventors: Moo Seop KIM, Daejeon (KR); SuGil CHOI, Daejeon (KR); Chi Yoon JEONG, Daejeon (KR); Sooncheol SHIN, Daejeon (KR)

(73) Assignee: Electronics and Telecommunications Research Institute, Daejeon (KR)

(21) Appl. No.: 13/859,417

(22) Filed: Apr. 9, 2013

(30) Foreign Application Priority Data
Oct. 23, 2012 (KR) 10-2012-0118057

(51) Int. Cl. H04L 29/06

(52) U.S. Cl. CPC H04L 63/0428
USPC 713/160

(57) ABSTRACT

An apparatus for providing a network data service, comprising: a packet distributor for dividing data inputted through a transmission side network in the unit of a packet and distributing the divided packet data in parallel; an area detection unit for detecting an object in an interest area in the packet data distributed in parallel and performing encryption on the detected object in the interest area; and a data transmission unit for transmitting the packet data encrypted by the area detection unit to a reception side network.

### RELATED APPLICATION(S)

This application claims the benefit of Korean Patent Application No. 10-2012-0118057, filed on Oct. 23, 2012, which is hereby incorporated by references as if fully set forth herein.

### FIELD OF THE INVENTION

The present invention relates to a network data service; and more particularly, to an apparatus and a method for providing a network data service and a client device for a network data service, which are suitable for effectively providing a privacy protection function for protecting privacy from various image contents generated in a distributed network-based network environment.

### BACKGROUND OF THE INVENTION

A conventional image data was mostly generated by a device of an offline environment, and restrictedly managed and used by a person, an enterprise or the like. Further, an image service was provided by an extremely limited service provider or site.

However, along with improvement of performance of a network platform and migration to a distributed network environment, anyone can record and store image contents anytime by using a webcam, an IP camera, a smart-phone or the like and transmit the image contents to a public site (YouTube or the like) that provides a file server system. Accordingly, the amount of image data transmitted in the distributed network is increasing explosively.

In the distributed network environment, the privacy is frequently disturbed indiscriminately by image data obtained regardless of person's intention or without permission. This problem is expected to become more serious along with popularization of smart devices, cost reduction of a webcam and improvement of a wired/wireless data communication technology.

Service providers or public sites cannot check whether or not the privacy is disturbed by explosively increasing image data. Server systems that store therein image data cannot provide a privacy protection function against all images, because it requires a considerably large amount of computing power and resources. If such function is applied to small-sized image devices as edge devices used by personal users in order to solve the above problem, additional apparatuses are required to support additional techniques, which results in cost increase of the devices. If additional apparatuses are not used, the performance of the devices deteriorate, which is not preferable.

Hence, a currently possible solution for preventing the above problems is to educate and instruct users who produce images in a moral point of view, and an intelligent image recognition technique is being introduced as an initial stage for technical solution in a state where a clear technical solution is not obtained.

### SUMMARY OF THE INVENTION

In view of the above, the present invention provides a network data service technique capable of effectively transmitting an image data while protecting personal information from a multichannel image data by masking personal information in an image data (e.g., personal face and important information or the like) by distributing in parallel packets of data transmitted to a server device or a relay device (e.g., a router, a switch, a hub or the like) between networks, particularly distributed networks, and analyzing the packet data.

In accordance with a first aspect of the present invention, there is provided an apparatus for providing a network data service, comprising: a packet distributor for dividing data inputted through a transmission side network in the unit of a packet and distributing the divided packet data in parallel; an area detection unit for detecting an object in an interest area in the packet data distributed in parallel and performing encryption on the detected object in the interest area; and a data transmission unit for transmitting the packet data encrypted by the area detection unit to a reception side network.

The area detection unit includes a plurality of area detection unit groups connected in parallel.

Further, the apparatus for providing a network data service comprising a packet distribution control unit for monitoring an analysis state of the packet data of the area detection unit groups and providing the monitored result to the packet distribution unit.

The apparatus for providing a network data service, wherein the area detection unit transmits, when the packet data is received from the packet distribution unit, a busy signal to the packet distribution control unit.

The apparatus for providing a network data service, wherein the area detection unit transmits, when the analysis of the packet data is completed, a free signal to the packet distribution control unit.

The apparatus for providing a network data service, wherein the data transmission unit inputs privacy protection processing result information into a partial area of the packet data provided from the area detection unit.

The apparatus for providing a network data service, wherein the packet distribution unit bypasses, when the privacy protection processing result information is included in the data inputted through the transmission side network, the data inputted through the transmission side network to the data transmission unit.

The apparatus for providing a network data service, wherein the area detection unit includes: a reception unit for receiving packet data distributed by the packet distribution unit; a storage unit for storing the packet data provided from the reception unit; a packet analysis unit for determining whether or not the packet data provided from the reception unit is an image data; an image decoding unit for decoding the image data based on the analysis result of the packet analysis unit; an object detection unit for detecting an object in an interest area in the image data decoded by the image decoding unit; and an object encryption unit for encrypting the object in the interest area detected by the object detection unit.

The apparatus for providing a network data service, wherein the object encryption unit performs encryption by using a preset encryption key.

The apparatus for providing a network data service, wherein the area detection unit further includes: an image encoding unit for restoring the image data encrypted by the object encryption unit in the form of packet data; and a packet output unit for outputting the packet data restored by the image encoding unit or the packet data stored in the packet storage unit.

The apparatus for providing a network data service, wherein the packet analysis unit bypasses, when the packet data provided from the receiving unit is not an image data, packet data stored in the packet storage unit to the packet output unit.

The apparatus for providing a network data service, wherein the packet analysis unit transmits, when the packet data provided from the receiving unit is not an image data, a free signal to the packet distribution control unit and then waits for reception of a next packet data.

The apparatus for providing a network data service, further comprising a network relay device or a network server device.

In accordance with a second aspect of the present invention, there is provided a method for providing a network data service, comprising: analyzing a packet data distributed in parallel by a packet distribution unit and determining whether or not the packet data is an image data; decoding the packet data when the packet data is an image data; detecting an interest area in the decoded image data; and performing encryption on the object in the detected interest area by using an encryption key.

The method for providing a network data service, wherein the encryption step is a step of applying a privacy protection function to the decoded image data.

The method for providing a network data service, further comprising: restoring the image data encrypted in the encryption step in the form of a network packet data; and providing the restored network packet data to the data transmission unit.

The method for providing a network data service, wherein the data transmission unit provides the image data to which the privacy protection function is applied to a reception side of a network.

In accordance with a third aspect of the present invention, there is provided a client device for a network data service, comprising: a receiving unit for receiving an image data provided through a network; an image decoding unit for performing decoding to convert the image data provided from the receiving unit into an externally displayable data; an image display unit for displaying the image data provided from the image decoding unit; and an object decryption unit for decrypting a masked portion in the image data provided from the image decoding unit, wherein the image display unit masks an object in an interest area of the image data which has not been decrypted by the object decryption unit.

The client device for a network data service, wherein the object decryption unit selectively decrypts the masked portion in the image data by using a preset encryption key.

In accordance with the present invention, the problem in which image data is indiscriminately obtained regardless of person's intention can be solved by distributing packets to various image data generated in a distributed network environment by using parallel processing in an intermediate portion of a network and protecting privacy from the image data. Moreover, the privacy protection function can be provided without additional costs by processing in real time image data generated by users in different network structures, and the image can be checked by releasing the privacy protection function when necessary.

### BRIEF DESCRIPTION OF THE DRAWINGS

The objects and features of the present invention will become apparent from the following description of embodiments, given in conjunction with the accompanying drawings, in which:

FIG. 1 shows an overall network including an apparatus for providing a network data service in accordance with an embodiment of the present invention;

FIG. 2 is a configuration block diagram showing the apparatus for providing a network data service in accordance with the embodiment of the present invention;

FIG. 3 is a detailed configuration block diagram showing an area detection unit of the apparatus for providing a network data service shown in FIG. 2;

FIG. 4 is a flowchart for exemplarily explaining a method for providing a network data service in accordance with an embodiment of the present invention; and

FIG. 5 is a configuration block diagram showing a client device for a network data service in accordance with an embodiment of the present invention.

### DETAILED DESCRIPTION OF THE EMBODIMENTS

Advantages and characteristics of the present invention, and a method of achieving them will be clear with reference to the following embodiments to be described below in detail. However, the present invention is not limited to the following embodiments, and may be implemented in various manners. The embodiments are disclosed merely to provide a complete description of the present invention and to provide complete understanding of the present invention to those skilled in the art to which the present invention belongs, and the present invention is only defined by the appended claims. Like reference numerals refer to like elements throughout the specification.

In describing the embodiments of the present invention, known functions or configuration may not be described fully if the detailed description thereof makes the scope of the present invention ambiguous. Further, the following terms are defined in consideration of functions in the embodiments of the present invention, and may vary in accordance with intentions of a user or an operator or according to usual practice. Therefore, the definitions of the terms should be interpreted on the basis of the entire content of the specification.

Combinations of blocks in the block diagrams and the steps in the flowcharts may be implemented by computer program instructions. These computer program instructions may be provided to a processor of a general purpose computer, special purpose computer, or other programmable data processing apparatus, so that the instructions executed via the processor of the computer or other programmable data processing apparatus can create units for implementing the functions described in the steps of the flowcharts or the blocks of the block diagrams. These computer program instructions may also be stored in a computer usable or computer-readable memory that may direct a computer or other programmable data processing apparatus to function in a particular manner, so that the instructions stored in the computer usable or computer-readable memory can produce an article of manufacture including instruction units that implement the functions specified in the steps of the flowcharts or the blocks of the block diagrams. The computer program instructions may also be loaded onto a computer or other programmable data processing apparatus to cause a series of operational steps to be performed on the computer or other programmable apparatus to produce a computer implemented process, so that the instructions that execute on the computer or other programmable apparatus can provide steps for implementing the functions specified in the steps of the flowcharts and the blocks of the block diagrams.

Further, the blocks of the steps may refer top arts of codes, segments, or modules that include one or more executable instructions for performing specified logic functions. Moreover, it should be noted that the functions described in the blocks or the steps may be performed in a different order from the embodiments described above. For example, the functions described in two adjacent blocks or steps may be performed substantially at the same time or in reverse order depending on corresponding functions.

Prior to the description of the embodiments of the present invention, the brief description of the present invention will be provided. The present invention analyzes image data generated by a CCTV (Closed Circuit Television), a webcam, a smart-phone or the like by using a parallel processing method in a network side before the image data transmitted through a network is stored in a service provider or a site, and then distributes the analyzed data in parallel. Thus, the area in the image where the privacy may be disturbed in parallel is masked or encrypted in parallel, which prevents personal information from being misused or abused in a distributed network or a public network. The purpose of the present invention can be easily achieved from the above technical scope.

The privacy protection technique for protecting privacy from image data in a network environment which is suggested by the present invention may include a technique that distributes data packets to effectively analyze packet data at the same time and process network data packets at a high speed and an image analysis technique that masks personal information in an image if the distributed packet data is analyzed to be an image data.

Hereinafter, embodiments of the present invention will be described in detail with reference to the accompanying diagrams so that they can be readily implemented by those skilled in the art.

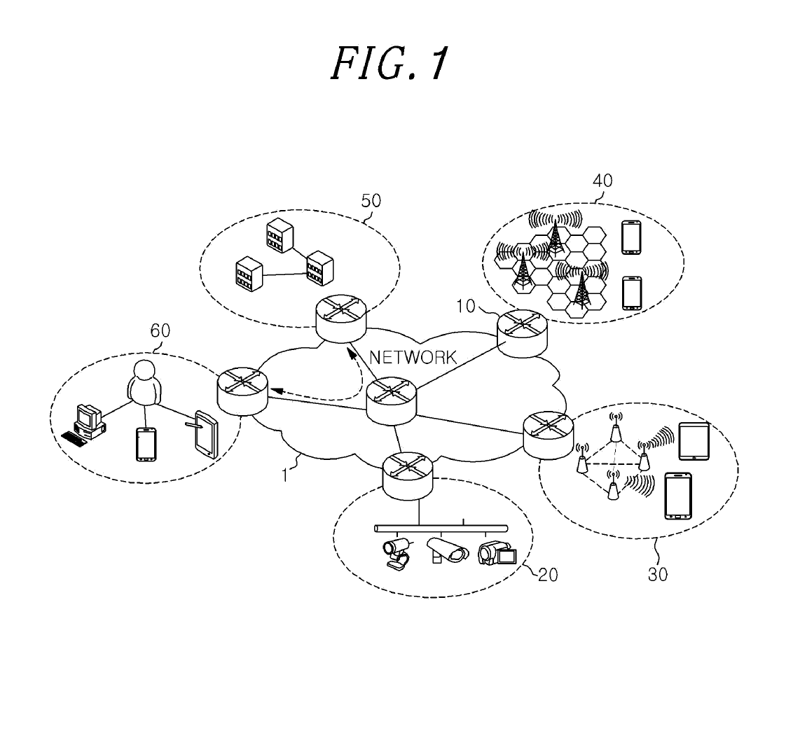

FIG. 1 shows an overall environment and configuration of a multichannel image network including an apparatus for providing a network data service in accordance with an embodiment of the present invention. The multichannel image network includes a network 1, an apparatus for providing a network data service 10, a wired network 20, a wireless network 30, a mobile network 40, a service provider 50, a service user 60 or the like.

As shown in FIG. 1, the image data produced in various network environments such as the service user 60, the wired network 20, the wireless network 30, the mobile network 40 and the like can be transmitted to and stored in the service provider 50.

In order to receive and transmit data between various networks, various intermediate connectors such as a router, a gateway and the like are needed. Most of current network relay devices perform a function of effectively transmitting data packets by checking destinations of transmitted data.

The apparatus for providing a network data service 10 in accordance with an embodiment of the present invention which is used for a technique for distributing packets in parallel and processing image in parallel is applied to a conventional network relay such as a router or the like to thereby protect privacy effectively.

The network relay to which the technique of the present invention is applied may refer to apparatuses including network equipments disposed right in front of a server device for storing therein data in a network structure as well as apparatuses such as a router and the like which are positioned between various networks.

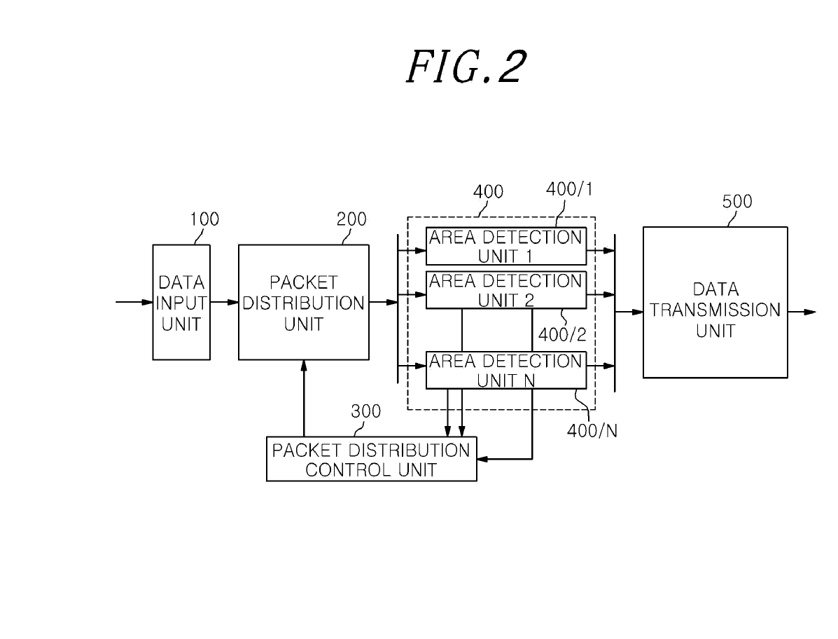

FIG. 2 is a configuration block diagram showing an apparatus for providing a network data service in accordance with an embodiment of the present invention, and is also a conceptual diagram showing a parallel data distribution technique that processes data transmitted in real time in parallel in order to effectively process the data shown in FIG. 1.

As shown in FIG. 2, the apparatus for providing a network data service may include a data input unit 100, a packet distribution unit 200, a packet distribution control unit 300, an area detection unit group 400, a data transmission unit 500, and the like. The apparatus for providing a network data service may include a relay device, a server device or the like, and is not limited to a specific apparatus as long as it can receive a network data (e.g., image data) at an intermediate side.

Referring to FIG. 2, the data input unit 100 can receive input of data that has been transmitted to a server device or a relay device including a router or the like through the network 1 and then transmit the data to the packet distribution unit 200 to be described later. The function of the data input unit 100 is obvious to those skilled in the art to which the present invention pertains, so that detailed description thereof will be omitted.

The packet distribution unit 200 performs a switching function by dividing data received through the network 1 in the unit of packet and distributes the divided data to the area detection unit group 400 connected in parallel. Accordingly, in the embodiment of the present invention, the privacy protection function can be effectively achieved. The information that determines an area detection unit in the area detection unit group 400 which will receive the data divided by the packet distribution unit 200 can be received from the packet distribution control unit 300.

The packet distribution control unit 300 checks information of an area detection unit that is performing data processing and that of an area detection unit that is not performing data processing by monitoring the state of the region detection unit group 400 connected in parallel in real time and transmits the monitoring result information to the packet distribution unit 200. The packet distribution unit 200 that has received the monitoring result information of the packet distribution control unit 300 transmits the packet data to the area detection unit that is currently not performing data processing based on the information such that the area detection unit group 400 connected in parallel can be effectively driven.

The area detection unit group 400 may include a plurality of area detection units 400/1 to 400/N connected in parallel, and analyzes the packet data received from the packet distribution unit 200.

Here, any one of the area detection units, e.g., an area detection unit 1 (400/1), informs, when any packet data is received from the packet distribution unit 200, start of analysis by transmitting a busy signal to the packet distribution control unit 300 and then starts the analysis of the received packet data.

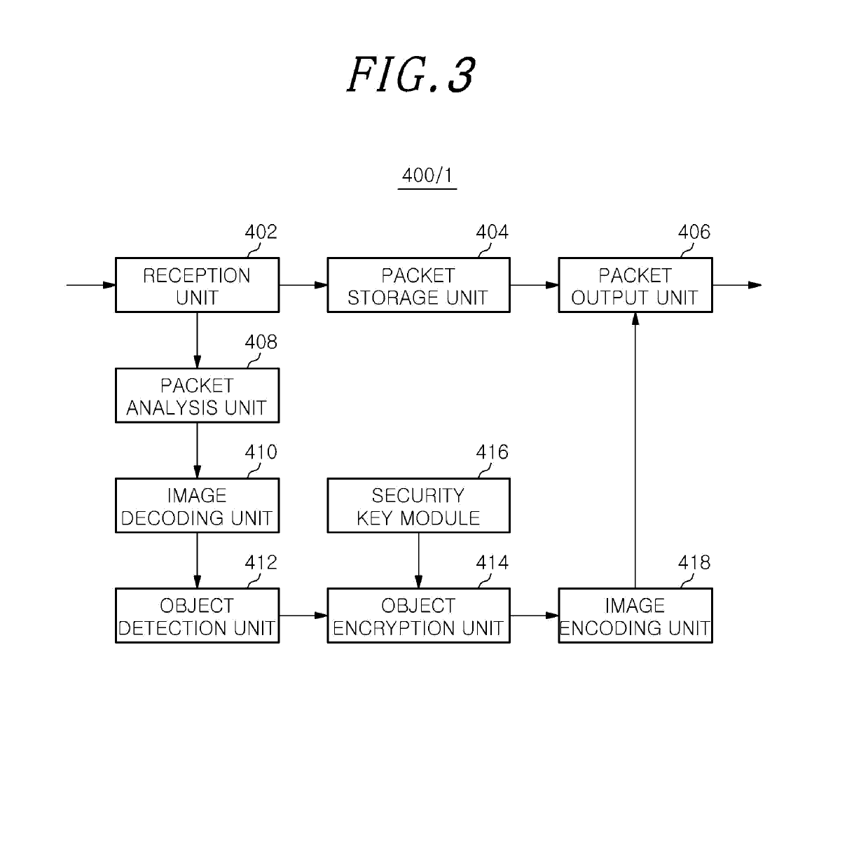

Upon completion of the analysis of an initial packet data (e.g., a first packet data), the area detection unit 1 (400/1) transmits a free signal to the packet distribution control unit 300 and then waits for a next packet data to be processed (e.g., a second packet data). The detection unit 1 (400/1) will be described in detail with reference to FIG. 3 to be described later.

The data transmission unit 500 transmits the packet data having a privacy protection function which has been parallel processed by the area detection unit group 400 to a destination (e.g., at least one of a wired network, a wireless network, a mobile network and a service provider) in a priority order or a preset transmission order.

At this time, the data transmission unit 500 can input information that displays the completion of the packet data protection processing in a part of the area of the transmission packet data (privacy protection processing result information) in order to prevent the data from being processed again by several routers or the like in the intermediate side of the network. Thus, the aforementioned packet distribution unit 200 can determine whether or not the privacy protection processing has been completed based on the privacy protection processing result information before the input data is distributed, and then directly bypass the data to the data transmission unit 500 without sending the corresponding data to the area detection unit group 400 if it is determined that the privacy protection processing has been completed.

FIG. 3 is a block diagram showing any one of the area detection units in the area detection unit group 400 shown in FIG. 2, e.g., an area detection unit 1 (400/1), which may include a reception unit 402, a packet storage unit 404, a packet output unit 406, a packet analysis unit 408, an image decoding unit 410, an object detection unit 412, an object encryption unit 414, a security key module 416, an image encoding unit 418 or the like.

As shown in FIG. 3, the reception unit 402 can receive the data (the parallel processed packet data) from the packet distribution unit 200 shown in FIG. 2. The packet data received by the reception unit 402 can be provided to the packet storage unit 404 and the packet analysis unit 408. Further, the reception unit 402 can receive the data from the packet distribution unit 200 and at the same time transmit a busy signal to the packet distribution control unit 300 in order to prevent another data transmission.

The packet storage unit 404 can store therein the packet data received by the reception unit 402. The packet output unit 406 can receive input of the data transmitted from the image encoding unit 418 to be described later or the data transmitted from the packet storage unit 404 and then transmit the data to the data transmission unit 500 shown in FIG. 2.

The data transmitted through the network may be a document type text data or may be another data. Therefore, it is required to check whether or not the data received by the reception unit 402 is an image data.

The packet analysis unit 408 can check whether or not the corresponding data is an image data (or a photo data) by analyzing a header of a data inputted through the reception unit or related information.

If the received data is neither an image data nor a photo data as the analysis result of the packet analysis unit 408, the data stored in the packet storage unit 404 is transmitted to the packet output unit 406 and, then, a free signal is transmitted to the packet distribution control unit 300. Next, the reception of a next packet data is waited.

On the contrary, if the received data is an image data or a photo data as the analysis result of the packet analysis unit 408, the following configurations can be utilized in order to perform the privacy protection function.

In most of image data or photo data, for effective transmission and storage of the data, the size of the original image is reduced by encoding although the quality of the image is slightly decreased. Therefore, in order to process the image in the packet data, the decoding is required to restore the image data.

The image decoding unit 410 can perform an overall function of restoring the image data transmitted while being compressed by codec.

The object detection unit 412 can check whether or not the restored image data has an interest area for protecting privacy, e.g., personal face or body, or the like, and then detect an object in the corresponding interest area if the interest area is included. The object detection unit 412 can detect information, e.g., coordinates, the size of the object, the location of the interest area or the like, by using a general technique.

The object encryption unit 414 can perform encryption (privacy protection) of the detected object area in the image data and provide the encrypted image data to the image encoding unit 418. Here, the encryption can be implemented through a preset encryption key provided from the security key module 416.

At this time, if the image has a plurality of object areas, the information of the objects can be selectively checked by using different encryption keys for the objects. Further, all the objects may be encrypted by the same encryption key and decrypted simultaneously. The encryption keys used for the objects may be generated in the form of a tree by using a key set in the security key module 416, or preset keys may be used alternately. A conventional module such as TMP may also be applied to the security key module. The encryption method used by the object encryption unit 414 may include general methods such as stream encryption using an encryption key, public key encryption or symmetric key encryption, and methods for disturbing a screen by inserting a pattern that prevents the output of the image from being recognized by naked eyes or irregularly changing positions in a certain area of the image.

The image encoding unit 418 can restore the image data to which the privacy protection function is applied in the form of a network packet data and transmit the restored data to the packet output unit 406. Especially, the image encoding unit 418 provides the image data together with information for synchronization of keys used for encoding to the packet output unit 406, so that the image can be selectively or entirely checked by the reception side. If the encryption key is not used, when the image is seen by the reception side, the object area is masked by noise so as not to be recognized by naked eyes.

When the data transmission from the packet output unit 406 to the data transmission unit 500 is completed, the packet output unit 406 can transmit a free signal and wait for an operation for next data.

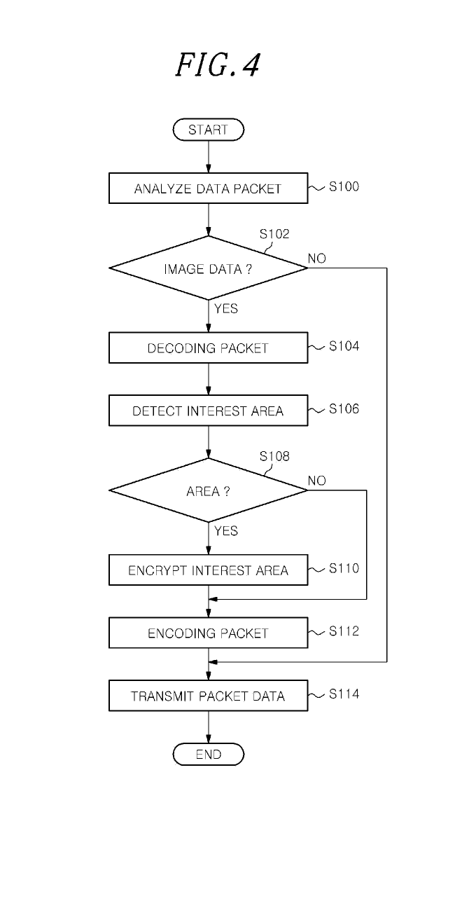

Hereinafter, with the above-described configuration, a method for providing a network data service of an apparatus for providing a network data service in accordance with an embodiment of the present invention will be described in detail with reference to the flowchart of FIG. 4.

As shown in FIG. 4, when the packet data distributed by the packet distribution unit 200 is provided to any area detection unit, e.g., the area detection unit 1 (400/1) (S100), the area detection unit 1 (400/1) analyzes the corresponding packet data and determines whether or not the corresponding packet data is an image data based on the analysis result (S102). Specifically, the packet data can be analyzed by the packet analysis unit 408 in the area detection unit 1 (400/1).

If the corresponding packet data is an image data as the analysis result of the area detection unit 1 (400/1), the detection unit 1 (400/1) can restore the image data by decoding the corresponding packet data (S104).

Next, the area detection unit 1 (400/1) can detect an interest area in the decoded image data (S106) and then encrypts an object in the detected interest area by using an encryption key (S108)(S110). Due to the encryption process, the privacy protection function can be applied to the corresponding image data.

Next, the area detection unit 1 (400/1) can perform a packet encoding process for restoring the image data to which the privacy protection function is applied to the form of a network packet data (S112).

The encoded packet data can be provided to the data transmission unit 500, and the data transmission unit 500 can provide the image data to which the privacy protection function is applied to the reception side of the corresponding network (e.g., a mobile terminal of a mobile network) (S114).

Hence, the mobile terminal of the transmission side can receive the image data to which the privacy protection function is applied, and the corresponding image can be recognized only when the aforementioned encryption key is used. If the encryption key is not used, when the image is seen by the reception side, the object area is masked by noise so as not to be recognized by naked eyes.

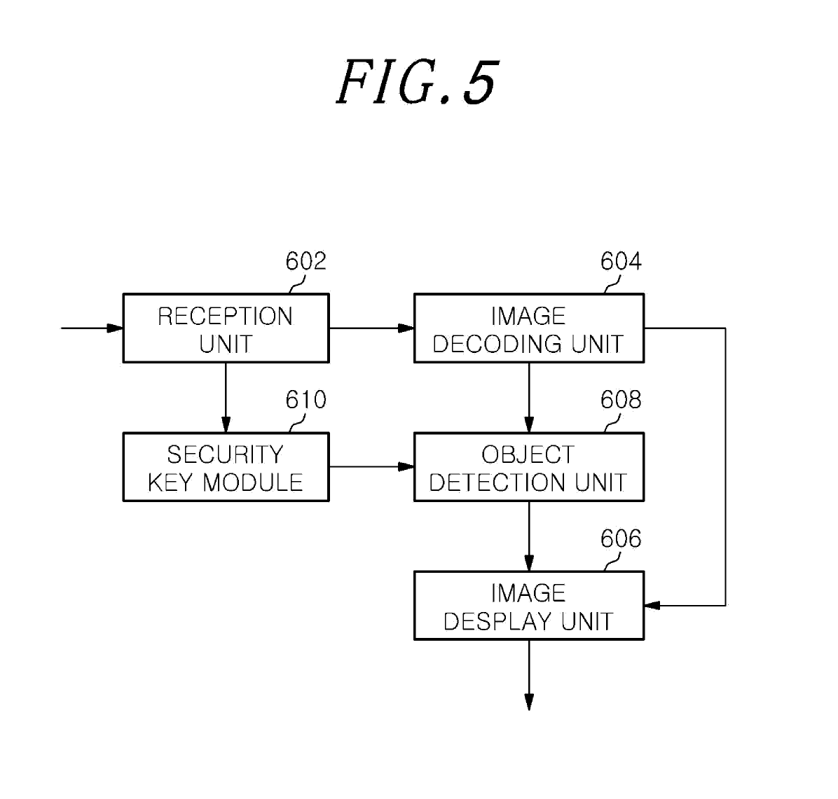

FIG. 5 is a configuration block diagram showing a client terminal for network data service in accordance with an embodiment of the present invention which has a privacy protection function, e.g., any terminal of the service user 60 shown in FIG. 1, which may include a reception unit 602, an image decoding unit 604, an image display unit 606, an object decryption unit 608, a security key module 610 or the like.

As shown in FIG. 5, the reception unit 602 can receive the image data provided through the network.

The image decoding unit 604 can perform decoding to convert the image data provided by the reception unit 602 into data that can be displayed outside of the client terminal.

The image display unit 606 can display the image data directly provided directly by the image decoding unit 604 or the image data provided by the image decoding unit 604 via the object decryption unit 608. For example, if there is no request for the image data decoded by the image decoding unit 604, the image display unit 606 can display the image data without decryption. Therefore, the object in the interest area is masked, and the user cannot recognize the image with naked eyes.

After the input image is decoded, the object decryption unit 608 decrypts the masked portion of the image to check the area of the object. The encryption key for the decoding of the image area is set in the security key module 610 by a preset method. When a part of the masked image is selectively decrypted, required coordinates, size or the like can be obtained during the decoding by the image decoding unit 604.

In accordance with the above-described embodiments of the present invention, the image data can be effectively transmitted while protecting personal information in the multi-channel image data by masking personal information in the image data (e.g., personal face, important information or the like) by distributing in parallel packets of data transmitted by a relay device (e.g., a router, a switch, a hub or the like) between networks, particularly distributed networks, and then analyzing the data packets.

While the invention has been shown and described with respect to the embodiments, the present invention is not limited thereto. It will be understood by those skilled in the art that various changes and modification may be made without departing from the scope of the invention as defined in the following claims.

What is claimed is:

1. An apparatus for providing a network data service, comprising:
a packet distributor for dividing data inputted through a transmission side network in the unit of a packet and distributing the divided packet data in parallel;
an area detection unit for detecting an object in an interest area in the packet data distributed in parallel and performing encryption on the detected object in the interest area; and
a data transmission unit for transmitting the packet data encrypted by the area detection unit to a reception side network.

2. The apparatus for providing a network data service of claim 1, wherein the area detection unit includes a plurality of area detection unit groups connected in parallel.

3. The apparatus for providing a network data service of claim 2, further comprising a packet distribution control unit for monitoring an analysis state of the packet data of the area detection unit groups and providing the monitored result to the packet distribution unit.

4. The apparatus for providing a network data service of claim 3, wherein the area detection unit transmits, when the packet data is received from the packet distribution unit, a busy signal to the packet distribution control unit.

5. The apparatus for providing a network data service of claim 3, wherein the area detection unit transmits, when the analysis of the packet data is completed, a free signal to the packet distribution control unit.

6. The apparatus for providing a network data service of claim 1, wherein the data transmission unit inputs privacy protection processing result information into a partial area of the packet data provided from the area detection unit.

7. The apparatus for providing a network data service of claim 6, wherein the packet distribution unit bypasses, when the privacy protection processing result information is included in the data inputted through the transmission side network, the data inputted through the transmission side network to the data transmission unit.

8. The apparatus for providing a network data service of claim 1, wherein the area detection unit includes:
a reception unit for receiving packet data distributed by the packet distribution unit;
a storage unit for storing the packet data provided from the reception unit;
a packet analysis unit for determining whether or not the packet data provided from the reception unit is an image data;
an image decoding unit for decoding the image data based on the analysis result of the packet analysis unit;
an object detection unit for detecting an object in an interest area in the image data decoded by the image decoding unit; and
an object encryption unit for encrypting the object in the interest area detected by the object detection unit.

9. The apparatus for providing a network data service of claim 8, wherein the object encryption unit performs encryption by using a preset encryption key.

10. The apparatus for providing a network data service of claim 8, wherein the area detection unit further includes:
an image encoding unit for restoring the image data encrypted by the object encryption unit in the form of packet data; and
a packet output unit for outputting the packet data restored by the image encoding unit or the packet data stored in the packet storage unit.

11. The apparatus for providing a network data service of claim 10, wherein the packet analysis unit bypasses, when the packet data provided from the receiving unit is not an image data, packet data stored in the packet storage unit to the packet output unit.

12. The apparatus for providing a network data service of claim 11, wherein the packet analysis unit transmits, when the packet data provided from the receiving unit is not an image data, a free signal to the packet distribution control unit and then waits for reception of a next packet data.

13. The apparatus for providing a network data service of claim 12, further comprising a network relay device or a network server device.

14. A method for providing a network data service, comprising:
analyzing a packet data distributed in parallel by a packet distribution unit and determining whether or not the packet data is an image data;
decoding the packet data when the packet data is an image data;
detecting an interest area in the decoded image data; and
performing encryption on the object in the detected interest area by using an encryption key.

15. The method for providing a network data service of claim 14, wherein the encryption step is a step of applying a privacy protection function to the decoded image data.

16. The method for providing a network data service of claim 14, further comprising:
restoring the image data encrypted in the encryption step in the form of a network packet data; and
providing the restored network packet data to the data transmission unit.

17. The method for providing a network data service of claim 16, wherein the data transmission unit provides the image data to which the privacy protection function is applied to a reception side of a network.

18. A client device for a network data service, comprising:
a receiving unit for receiving an image data provided through a network;
an image decoding unit for performing decoding to convert the image data provided from the receiving unit into an externally displayable data;
an image display unit for displaying the image data provided from the image decoding unit; and
an object decryption unit for decrypting a masked portion in the image data provided from the image decoding unit,
wherein the image display unit masks an object in an interest area of the image data which has not been decrypted by the object decryption unit.

19. The client device for a network data service of claim 18, wherein the object decryption unit selectively decrypts the masked portion in the image data by using a preset encryption key.
